(19) United States
(12) Patent Application Publication
(10) Pub. No.: US 2015/0015168 A1
(43) Pub. Date: Jan. 15, 2015

(54) VEHICULAR DRIVING SYSTEM

(71) Applicant: TOYOTA JIDOSHA KABUSHIKI KAISHA, Toyota-shi (JP)

(72) Inventor: Yasuhiro TERAO, Okazaki-shi (JP)

(21) Appl. No.: 14/313,202

(22) Filed: Jun. 24, 2014

(30) Foreign Application Priority Data
Jul. 12, 2013 (JP) 2013-146702

(51) Int. Cl. H02P 3/18

(52) U.S. Cl. CPC H02P 3/18
USPC 318/139

(57) ABSTRACT

A vehicular driving system includes a rotating electric machine, an inverter and a controller. The rotating electric machine is constantly connected to an axle shaft. The inverter has an upper-arm device and a lower-arm device corresponding to each of three phases of the rotating electric machine. The inverter is configured to perform electric power conversion between a DC power supply and the rotating electric machine and to supply three-phase AC power to the rotating electric machine. The controller is configured to perform an operation to reduce a rotational speed of the rotating electric machine when a short-circuit fault occurs to the inverter.

### INCORPORATION BY REFERENCE

The disclosure of Japanese Patent Application No. 2013-146702 filed on Jul. 12, 2013 including the specification, drawings and abstract is incorporated herein by reference in its entirety.

### BACKGROUND OF THE INVENTION

1. Field of the Invention

The invention relates to a vehicular driving system, and in particular, to a vehicular driving system in which an axle shaft and a three-phase AC rotating electric machine are constantly connected to each other.

2. Description of Related Art

In the related art, a vehicular driving system in which an axle shaft and a three-phase AC rotating electric machine are connected to each other is known (see, for example, Japanese Patent Application Publication No. 2008-011683 (JP 2008-011683 A)). The vehicular driving system includes an inverter that performs electric power conversion between a DC power supply and the three-phase AC rotating electric machine. The inverter has an upper arm and a lower arm corresponding to each of the three phases of the rotating electric machine.

The vehicular driving system described in JP 2008-011683 A as indicated above is able to detect a short-circuit fault in the inverter. If the driving system detects a short-circuit fault occurring in a switching device of an arm of any phase that constitutes the inverter, it performs a switching operation on an arm of a phase different from the phase that suffers from the short-circuit fault, so as to control electric current flowing through a coil of each phase of the motor. With this arrangement, it is possible to keep driving the three-phase AC rotating electric machine while reducing current flowing in the arm in which the short circuit occurred. Accordingly, the vehicular driving system as described above makes it possible to run the vehicle in a limp-home mode, by keeping driving the three-phase AC rotating electric machine, while making an attempt to protect components, at the time of a short-circuit fault in the inverter.

In the meantime, in the vehicular driving system described in JP 2008-011683 A as indicated above, the engine and the rotating electric machine are connected to the axle shaft via a power split device, and the driving force generated by rotation of the engine can be distributed to a path through which the driving force is transmitted to the rotating electric machine via the power split device, and a path through which the driving force is transmitted to the axle shaft. In the vehicular driving system, only a part of the driving force generated by rotation of the engine can be transmitted to the rotating electric machine at the time of a short-circuit fault in the inverter. Accordingly, in the vehicular driving system described in JP 2008-011683 A, it is possible to curb occurrence of overcurrent, and prevent components, such as the rotating electric machine and wire harness, from being broken in a short period of time.

On the other hand, another type of vehicular driving system is known in which an engine, a rotating electric machine, and an axle shaft are connected in series. Namely, the rotating electric machine is constantly connected to the engine, and is constantly connected to the axle shaft. In the vehicular driving system thus configured, the whole of the driving force generated by rotation of the engine is transmitted to the axle shaft via the rotating electric machine. Therefore, if the driving force is transmitted as usual when a short-circuit fault occurs to the inverter, overcurrent is likely to be produced since the rotating electric machine rotates at a high speed when the engine rotates at a higher speed. As a result, in the vehicular driving system as described above, components, such as the rotating electric machine and wire harness, may be broken or damaged in a short period of time. In order to prevent the components, such as the rotating electric machine, from being broken, it may be considered to disconnect the engine and the rotating electric machine from each other at the time of the short-circuit fault in the inverter. However, this arrangement makes it difficult to keep driving the rotating electric machine at the time of the short-circuit fault in the inverter, thus making it difficult to run the vehicle in the limp-home mode.

### SUMMARY OF THE INVENTION

The invention provides a vehicular driving system capable of preventing components from being broken in a short period of time while allowing a three-phase rotating electric machine to be kept driven at the time of a short-circuit fault in an inverter.

A vehicular driving system according to one aspect of the invention includes a rotating electric machine, an inverter, and a controller. The rotating electric machine is constantly connected to an axle shaft. The inverter has an upper-arm device and a lower-arm device corresponding to each of three phases of the rotating electric machine. The inverter is configured to perform electric power conversion between a DC power supply and the rotating electric machine and to supply three-phase AC power to the rotating electric machine. The controller is configured to perform an operation to reduce a rotational speed of the rotating electric machine when a short-circuit fault occurs to the inverter.

According to the above aspect of the invention, it is possible to prevent components from being broken in a short period of time while allowing the three-phase rotating electric machine to be kept driven at the time of a short-circuit fault in the inverter.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing the configuration of a vehicular driving system as one embodiment of the invention;

FIG. 2 is a view showing flow of electric current when a short-circuit fault occurs to an inverter in the vehicular driving system of this embodiment, and flow of commands generated by a control unit after occurrence of the short-circuit fault; and

FIG. 3 is a flowchart illustrating one example of control routine executed in the vehicular driving system of this embodiment.

### DETAILED DESCRIPTION OF EMBODIMENTS

A vehicular driving system according to one embodiment of the invention will be described with reference to the drawings.

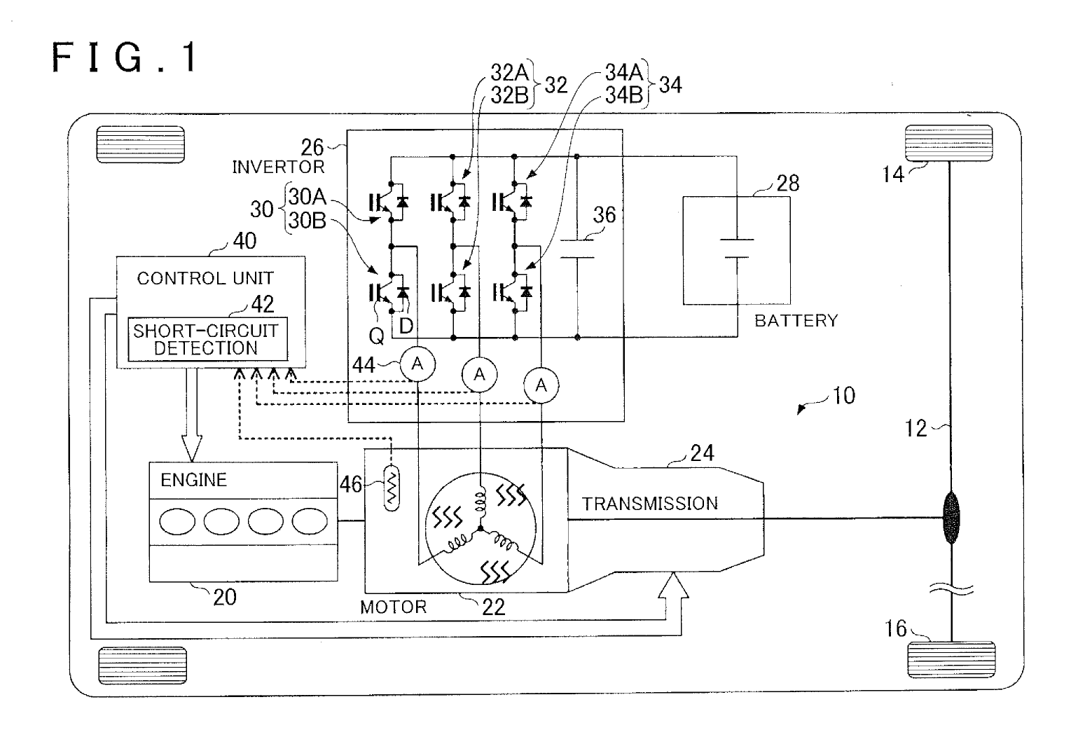

FIG. 1 shows the configuration of a vehicular driving system 10 as one embodiment of the invention. The vehicular driving system 10 of this embodiment is a driving system for driving an axle shaft 12, i.e., driving wheels 14, 16, of a hybrid vehicle.

The vehicular driving system 10 includes an engine 20, a motor-generator 22, and a transmission 24. The engine 20 generates driving force for rotating the axle shaft 12, with fuel injected into the engine 20. The motor-generator 22 generates driving force for rotating the axle shaft 12, with electric power supplied to the motor-generator 22. The transmission 24 is configured to be able to change the gear position when it transmits the driving force generated by the engine 20 and/or the motor-generator 22 to the axle shaft 12.

The engine 20, motor-generator 22, transmission 24, and the axle shaft 12 are connected in series in the order of description. Namely, the engine 20 and the motor-generator 22 are constantly connected to each other, and the motor-generator 22 and the axle shaft 12 are constantly connected via the transmission 24. Therefore, rotation of the engine 20 causes the motor-generator 22 to rotate, and is then transmitted to the axle shaft 12 after its speed is changed by the transmission 24.

The motor-generator 22 is a three-phase AC motor-generator having three coils of U phase, V phase and W phase, which coils are all connected at one end thereof to a neutral point. The motor-generator 22 functions as an electric motor that generates driving force so as to rotate the axle shaft 12 with electric power supplied thereto, and also functions as a generator that generates electric power with driving force received from the axle shaft 12 and/or the engine 20.

The vehicular driving system 10 also includes an inverter 26. The inverter 26 is a three-phase inverter interposed between a chargeable/dischargeable battery 28, such as a lithium-ion battery or a nickel-metal-hydride battery, and the motor-generator 22. The inverter 26 is configured to convert DC power supplied from the battery 28 into AC power, to deliver the AC power to the motor-generator 22, and also convert AC power supplied from the motor-generator 22 into DC power, to deliver the DC power to the battery 28. A step-up converter may be provided between the battery 28 and the inverter 26. The step-up converter includes a reactor having an energy storage function, and a pair of switching devices adapted to be turned ON/OFF so as to raise the DC voltage of the DC power supply, utilizing the energy storage function of the reactor.

The inverter 26 has upper and lower arms 30, 32, 34 corresponding to the three phases of the motor-generator 22, respectively, and a smoothing capacitor 36. The U-phase upper and lower arm 30, V-phase upper and lower arm 32, W-phase upper and lower arm 34, and the smoothing capacitor 36 are connected in parallel between the positive electrode and negative electrode of the battery 28. Each of the upper and lower arms 30, 32, 34 of the respective phases is constituted by an upper-arm device 30A, 32A, 34A, and a lower-arm device 30B, 32B, 34B.

The upper-arm device 30A, 32A, 34A and lower-arm device 30B, 32B, 34B of the upper and lower arm 30, 32, 34 of each phase are connected in series between the positive electrode and negative electrode of the battery 28. A middle point between the upper-arm device 30A, 32A, 34A and lower-arm device 30B, 32B, 34B of the upper and lower arm 30, 32, 34 of each phase is connected to the other end of the coil of the corresponding phase of the three-phase AC motor 12.

The upper-arm device 30A, 32A, 34A of each phase includes a switching device Q that performs switching operation, and a diode D. The switching device Q and the diode D are connected in parallel. Each switching device Q is a power transistor, such as IGBT, for example. The diode D is an inverse-parallel diode that permits flow of electric current in a direction opposite to the direction of flow of current in the switching device Q. Namely, the diode D permits flow of current from the emitter side to collector side of the IGBT as the switching device Q. The switching device Q may be a power device, such as MOSFET, other than IGBT. The inverter 26 performs power conversion between DC power and AC power, when the switching device Q of the upper-arm device 30A, 32A, 34A of each phase and the switching device Q of the lower-arm device 30B, 32B, 34B of each phase are alternately turned on/off while the phases of the three-phase upper and lower arms 30, 32, 34 are shifted by 120° from each other.

The vehicular driving system 10 includes a control unit 40 that is mainly constituted by a microcomputer. The control unit 40 performs various controls, through software processing with CPU executing pre-stored programs, and/or hardware processing using electronic circuits. The control unit 40 has a function of controlling ON/OFF of the switching devices Q of each phase. Also, the control unit 40 has a function of controlling the rotational speed of the engine 20, and a function of controlling the gear position of the transmission 24.

For example, the control unit 40 creates a signal for switching the switching devices Q of the inverter 26, based on a required torque value indicative of torque required to be generated by the motor-generator 22. The control unit 40 then outputs the thus created signal to each of the switching devices Q of the inverter 26. In this case, the inverter 26 performs switching operation according to the signal from the control unit 40, so as to convert DC power of the battery 28 into AC power, and deliver the AC power to the motor-generator 22. In this manner, the motor-generator 22 is driven so as to generate the required torque.

Also, the control unit 40 creates a signal for switching the switching devices Q of the inverter 26, which signal is needed for regenerative braking of the vehicle, based on the voltage between the opposite terminals of the battery 28 and the amount of electric power stored in the battery 28. The control unit 40 then outputs the thus created signal to each of the switching devices Q of the inverter 26. In this case, the inverter 26 performs switching operation according to the signal from the control unit 40, so as to convert AC power from the motor-generator 22 into DC power, and deliver the DC power to the battery 28. In this manner, the battery 28 is charged through regenerative braking of the vehicle.

The control unit 40 has a short-circuit detecting portion 42. The short-circuit detecting portion 42 detects a short-circuit fault occurring to any of the switching devices Q included in the inverter 26. The short-circuit detecting portion 42 may detect a short-circuit fault, based on a value of current flowing in each switching device Q of the inverter 26 while an OFF command is being generated to the switching device Q, for example. In this case, a current sensor 44 may be provided for each-phase output of the inverter 26, as shown in FIG. 1 by way of example, and a short-circuit fault may be detected based on an output signal of the current sensor 44.

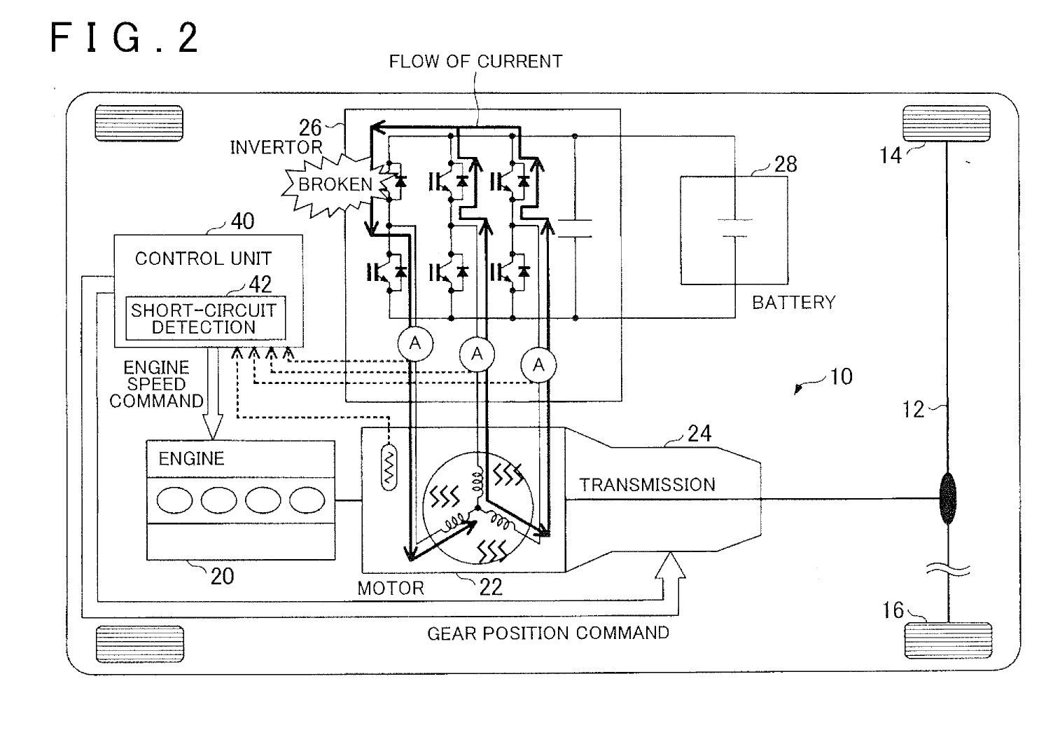

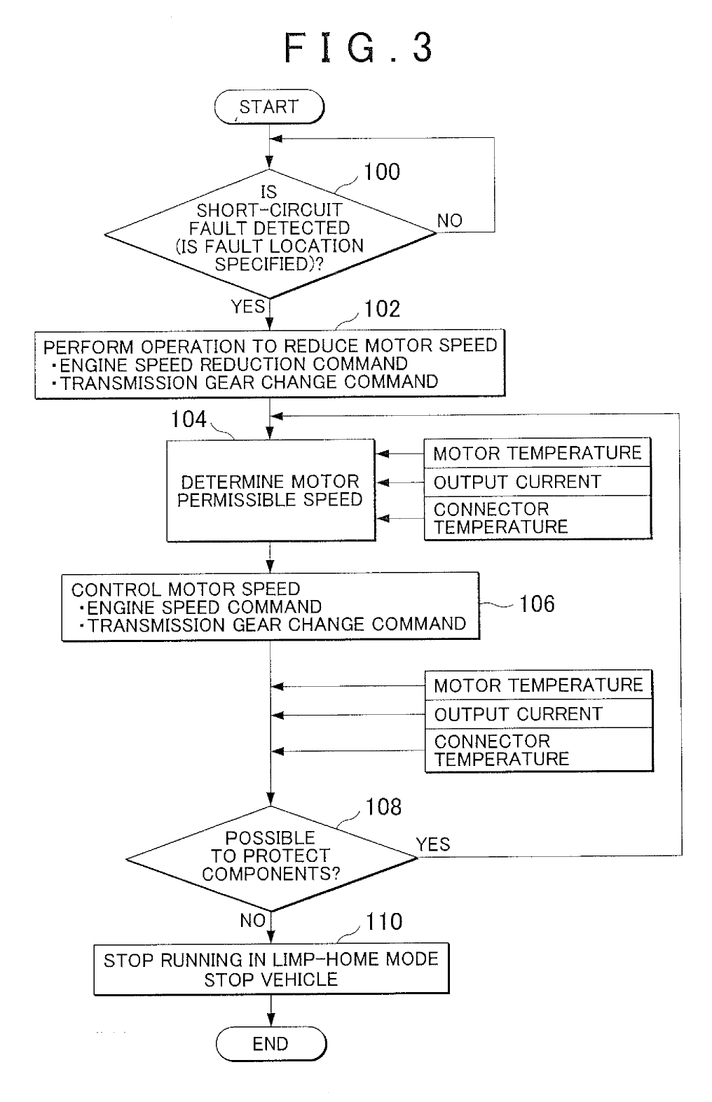

FIG. 2 shows flow (more specifically, paths indicated by arrows) of electric current which appear when a short-circuit fault occurs to the inverter 26 in the vehicular driving system 10 of this embodiment, and flow of commands generated by the control unit 40 after the short-circuit fault is detected. FIG. 3 is a flowchart illustrating one example of control routine executed by the control unit 40 in the vehicular driving system 10 of this embodiment.

In the vehicular driving system 10 of this embodiment, driving force (power) generated by the engine 20 is transmitted to the axle shaft 12 via the motor-generator 22. At this time, the motor-generator 22 rotates in accordance with rotation of the engine 20. The rotation of the motor-generator 22 accompanying the rotation of the engine 20 also takes place when a short-circuit fault occurs to the switching device Q of any phase of the inverter 26.

If the motor-generator 22 rotates when a short-circuit fault occurs to any switching device Q in the inverter 26, back electromotive force is produced in the motor-generator 22, in a condition where a closed circuit of a path including the switching device Q to which the short-circuit fault occurred is formed in the inverter 26. If the back electromotive force is produced, current flows along the paths indicated by thick arrows in

FIG. 2, for example. The amount of the current flowing along the paths increases as the rotational speed of the motor-generator 22 increases. Therefore, if the motor-generator 22 rotates as usual according to rotation of the engine 20, at the time of a short-circuit fault in the inverter 26, the motor-generator 22 rotates at a high speed when the engine 20 rotates at a high speed. Accordingly, overcurrent is likely to be produced, and a period of time from the occurrence of the short-circuit fault in the inverter 26 to the time when components, such as the inverter 26 and .the motor-generator 22, generate heat and get broken due to the continued flow of the overcurrent may be shortened.

Thus, when the vehicular driving system 10 of this embodiment detects a short-circuit fault in the inverter 26, it makes overcurrent less likely or unlikely to be produced, by reducing the rotational speed of the motor-generator 22, while allowing the motor-generator 22 to keep rotating in accordance with rotation of the engine 20. The characteristics of this embodiment will be hereinafter explained.

In the vehicular driving system 10 of this embodiment, the short-circuit detecting portion 42 of the control unit 40 determines whether a short-circuit fault occurs to any switching device Q included in the inverter 26, using the current sensors 44, or the like. When the control unit 40 detects a short-circuit fault in the inverter 26, it may specify the switching device Q to which the short-circuit fault occurred.

If the control unit 40 determines that a short-circuit fault occurs to one of the switching devices Q of the inverter 26 (i.e., if an affirmative decision (YES) is made in step 100), the control unit 40 performs an operation to reduce the rotational speed of the motor-generator 22 (step 102).

More specifically, the operation to reduce the rotational speed of the motor-generator 22 is performed by reducing the rotational speed of the engine 20, or shifting the gear position of the transmission 24 to higher speed gear. Note that the gear ratio of the transmission 24 is decreased as the gear position of the transmission 24 is shifted to higher speed gear. The operation to reduce the rotational speed of the motor-generator 22 may be an operation to make the rotational speed of the motor-generator 22 measured after detection of the short-circuit fault in the inverter 26, lower than that of the motor-generator 22 measured before detection of the short-circuit fault (by reducing the engine speed or shifting the transmission into higher speed gear). Also, the operation to reduce the rotational speed of the motor-generator 22 may be an operation to reduce the rotational speed of the motor-generator 22 down to a threshold value predetermined in the light of protection of components, or lower, (by reducing the engine speed to a given speed, or shifting the transmission into given gear (e.g., highest speed gear)).

In the above step 102, the control unit 40 generates a command to reduce the engine speed, to the engine 20, and generates a command to shift the gear position of the transmission 24 to higher speed gear, as the operation to reduce the rotational speed of the motor-generator 22. If the transmission 24 is already placed in the highest-speed gear position when the short-circuit fault in the inverter 26 is detected, there is no need to shift the transmission 24 into higher speed gear.

Once the above-mentioned commands are generated, the rotational speed of the engine 20 is reduced, and the gear position of the transmission 24 is shifted to higher speed gear. If the rotational speed of the engine 20 is reduced, the rotational speed of the motor-generator 22 is reduced in accordance with reduction of the rotational speed of the engine 20. If the gear position of the transmission 24 is shifted to higher speed gear, the rotational speeds of the motor-generator 22 and the engine 20 are reduced even if the rotational speed of the axle shaft 12 remains unchanged. If the rotational speed of the motor-generator 22 is reduced, the amount of current flowing through the closed circuit at the time of the short-circuit fault in the inverter 26 is reduced.

With the vehicular driving system 10 of this embodiment configured as described above, overcurrent is less likely or unlikely to be produced at the time of the short-circuit fault in the inverter 26. Therefore, according to this embodiment, the period of time from the occurrence of the short-circuit fault in the inverter 26 to the time when the components, such as the inverter 26 and the motor-generator 22, generate heat and get broken due to continued flow of the overcurrent can be prolonged. Also, at the time of the short-circuit fault in the inverter 26, components, such as the motor-generator 22, and wire harness that connects the inverter 26 with the motor-generator 22, can be prevented from generating heat and get broken in a short period of time. Thus, the above-indicated components can be protected as much as possible, against the short-circuit fault in the inverter 26, and the necessity of replacing the above components by new ones along with the inverter 26, due to the short-circuit fault in the inverter 26, can be reduced or eliminated. Accordingly, the cost of repair caused by the short-circuit fault in the inverter 26 can be reduced.

In this embodiment, the engine 20, motor-generator 22, transmission 24, and the axle shaft 12 are connected in series in the order of description. Also, the engine 20 and the motor-generator 22 are constantly connected to each other, and the motor-generator 22 and the axle shaft 12 are constantly connected via the transmission 24. In this regard, the driving force generated by the engine 20 causes the motor-generator 22 to rotate, and is then transmitted to the axle shaft 12 via the transmission 24 in which the speed is changed. Namely, the driving force generated by the engine 20 cannot be transmitted to the axle shaft 12 without going through the motor-generator 22. Therefore, according to this embodiment, the motor-generator 22 can be kept rotated/driven with the engine power, to rotate/drive the axle shaft 12, even at the time of a short-circuit fault in the inverter 26; consequently, the vehicle's ability to run in a limp-home mode can be ensured.

In this embodiment, at the time of a short-circuit fault in the inverter 26, the rotational speed of the motor-generator 22 is reduced by reducing the rotational speed of the engine 20, as described above, and, at the same time, the gear position of the transmission 24 is shifted to higher speed gear. If the higher speed gear is selected as the gear position of the transmission 24, the axle shaft 24 can be rotated at a higher speed, as compared with the case where the lower speed gear is selected, even if the rotational speed of the engine 20 is reduced. Thus, the running performance of the vehicle when it runs in a limp-home mode can be improved.

Thus, according to the vehicular driving system 10 of this embodiment, at the time of a short-circuit fault in the inverter 26, it is possible to prevent the components, such as the motor-generator 22 and the wire harness, from being broken in a short period of time, due to flow of short-circuit current, while allowing the three-phase AC motor-generator 22 to be continuously driven.

In the vehicular driving system 10 of this embodiment, once the control unit 40 starts performing the operation to reduce the rotational speed of the motor-generator 22 in the above step 102, the control unit 40 initially sets the maximum permissible rotational speed (permissible rotational speed) of the motor-generator 22 (step 104).

After the operation to reduce the rotational speed of the motor-generator 22 starts being performed, the permissible rotational speed of the motor-generator 22 may be set, based on the current (inverter output current) that flows to the output of each phase of the inverter 26, the temperature (motor temperature) that appears in the motor-generator 22, the temperature (W/H temperature) that appears in the wire harness connecting the motor-generator 22 with the inverter 26, the temperature (connector temperature) that appears in a connecting portion (connector) of the wire harness, and so forth. The inverter output current may be detected based on the output signal of the current sensor 44 for each phase. The motor temperature may be detected based on an output signal of a temperature sensor 46 installed in the motor-generator 22 as shown in FIG. 1.

For example, the permissible rotational speed of the motor-generator 22 may be set to a lower value as the inverter output current is larger, or may be set to a lower value as the motor temperature, W/H temperature, or connector temperature is higher. The permissible rotational speed of the motor-generator 22 may also be set to a lower value in the case where the inverter output current exceeds a given threshold value at which the components are expected to be likely to be broken, as compared with that in the case where the inverter output current does not exceed the threshold value. The permissible rotational speed of the motor-generator 22 may also be set to a lower value in the case where the motor temperature, W/H temperature, or connector temperature exceeds a given threshold value at which the components are expected to be likely to be broken, as compared with that in the case where the temperature does not exceed the threshold value.

After the control unit 40 sets the permissible rotational speed of the motor-generator 22 in the above step 104 after starting the operation to reduce the rotational speed of the motor-generator 22, the control unit 40 controls the rotational speed of the motor-generator 22 to within a range that does not exceed the permissible rotational speed set in step 104 (step 106). The rotational speed of the motor-generator 22 may be controlled by controlling the rotational speed of the engine 20 and the gear position of the transmission 24.

After the control unit 40 starts controlling the rotational speed of the motor-generator 22 in the above step 106, it determines whether the components, such as the motor-generator 22 and the wire harness, can be protected, with the rotational speed of the motor-generator 22 thus controlled (step 108). This determination may be made based on the result of monitoring of the inverter output current, motor temperature, W/H temperature, or connector temperature. For example, if the inverter output current tends to be high, or the motor temperature, W/H temperature, or connector temperature tends to be high, even after the rotational speed is controlled, it may be deemed difficult to protect the components. On the other hand, if the above-described tendencies are not found, it may be determined that the components can be protected.

If the control unit 40 determines in the above step 108 that the components can be protected, it repeatedly executes the above step 104 and subsequent steps. If, on the other hand, the control unit 40 finds it difficult to protect the components, the control unit 40 inhibits the engine 20 from generating driving force, so as to inhibit the vehicle from running in the limp-home mode and stop the vehicle (step 110).

With the above arrangement, after the operation to reduce the rotational speed of the motor-generator 22 is started due to a short-circuit fault in the inverter 26, the rotational speed of the motor-generator 22 can be allowed to be set to the highest possible speed while being controlled to within the range in which the constituent components can be protected. Thus, according to the vehicular driving system 10 of this embodiment, it is possible to improve the running performance of the vehicle in the limp-home mode, while surely preventing breakage of the components due to flow of the short-circuit current, at the time of a short-circuit fault in the inverter 26.

In the above-described embodiment, the motor-generator 22 may be regarded as “rotating electric machine” of the invention. Also, the control unit 40 may be regarded as “controller” of the invention.

In the above-described embodiment, the rotational speed of the engine 20 is reduced, and the gear position of the transmission 24 is shifted to higher speed gear, as the operation to reduce the rotational speed of the motor-generator 22 at the time of a short-circuit fault in the inverter 26. However, any one of the reduction of the rotational speed of the engine 20 and shifting of the gear position of the transmission 24 to higher speed gear may be performed as the operation to reduce the rotational speed of the motor-generator 22 at the time of a short-circuit fault in the inverter 26.

What is claimed is:

1. A vehicular driving system comprising:
a rotating electric machine constantly connected to an axle shaft;
an inverter having an upper-arm device and a lower-arm device corresponding to each of three phases of the rotating electric machine, the inverter being configured to perform electric power conversion between a DC power supply and the rotating electric machine and to supply three-phase AC power to the rotating electric machine; and
a controller configured to perform an operation to reduce a rotational speed of the rotating electric machine when a short-circuit fault occurs to the inverter.

2. The vehicular driving system according to claim 1, further comprising
an engine constantly connected to the rotating electric machine, wherein
the controller is configured to reduce a rotational speed of the engine to perform the operation to reduce the rotational speed of the rotating electric machine.

3. The vehicular driving system according to claim 2, wherein
the controller is configured to set a permissible rotational speed for the rotating electric machine when the short-circuit fault occurs, and
the controller is configured to control the rotational speed of the engine after starting performing the operation, so that the rotational speed of the rotating electric machine does not exceed the permissible rotational speed.

4. The vehicular driving system according to claim 1, further comprising
a transmission interposed between the rotating electric machine and the axle shaft, wherein
the controller is configured to shift a gear position of the transmission to higher speed gear than the gear position established before the short-circuit fault occurs to the inverter in the operation to reduce the rotational speed of the rotating electric machine.

5. The vehicular driving system according to claim 4, wherein
the controller is configured to set a permissible rotational speed for the rotating electric machine when the short-circuit fault occurs, and
the controller is configured to control the gear position of the transmission after starting performing the operation, so that the rotational speed of the rotating electric machine does not exceed the permissible rotational speed.

6. The vehicular driving system according to claim 1, further comprising
a transmission interposed between the rotating electric machine and the axle shaft, wherein
when a gear position of the transmission is a lower speed gear position than a predetermined gear position, the controller is configured to shift the gear position to the predetermined gear position in the operation to reduce the rotational speed of the rotating electric machine.
